(19) United States
(12) Patent Application Publication
(10) Pub. No.: US 2005/0058976 A1
(43) Pub. Date: Mar. 17, 2005

(54) Program for teaching algebra

(76) Inventor: David H. Vernon, Dallas, TX (US)

Correspondence Address: David W. Carstens;Carstens Yee & Cahoon, LLP, Suite 900, 13760 Noel Road, Dallas, TX, 75240, US

(21) Appl. No.: 10/886,445

(22) Filed: Jul. 7, 2004

Related U.S. Application Data
(60) Provisional application No. 60/503,355, filed on Sep. 16, 2003.

(51) Int. Cl. G06N 5/00; G09B 7/00; G09B 3/00; G06F 17/00

(52) U.S. Cl. 434/322

(57) ABSTRACT

A method and program for monitoring and checking students in solving mathematical problems are provided by the present invention. The invention monitors student choices as the student walks through the steps of solving a problem and provides feedback to the user indicating whether or not the user's input is correct. The invention determines if a newly entered statement correctly follows from the previous statement according to mathematical rules. The two statements are analyzed for common sub-expressions and compared against a database of mathematical rules. The database may include invalid rules corresponding to common mistakes. The invention then provides the user feedback in the form of the rule to which the user's input corresponds. If no rule is found in the database, a general error signal is provided.

### 1. CROSS-REFERENCE TO RELATED APPLICATION

This application claims the benefit of and priority to a U.S. Provisional Patent Application No. 60/503,355 filed Sep. 16, 2003, the technical disclosure of which is hereby incorporated herein by reference.

### BACKGROUND OF THE INVENTION

1. Technical Field

The present invention relates generally to educational software, and more specifically to software that monitors user choices and provides feedback to the user in real time.

2. Description of Related Art

Educational software is rapidly growing in popularity, both in schools and for home use.

Of particular importance are mathematical programs. Currently, there are several products available that apply symbolic algebra. These programs allow users to enter a problem and then perform some type of symbolic routine on it. For example, one program, has a “simplify” routine in which the user enters an expression and then selects the simplify function from a menu. The program takes over, simplifies the expression automatically and presents the results to the user. Other programs work in a similar manner, with different user interfaces and different sets of available routines.

Such programs enable the user to work with mathematics but do not actually help the user learn to perform the mathematical operations. Instead, the programs simply require the user to provide an initial input, and then the software performs the necessary operations automatically.

Other educational programs do provide instruction concerning the individual steps involved in mathematical operations. However, these programs specifically direct the student through the steps of solving a problem, and tend to enforce a particular educational rubric or methodology.

Therefore, it would be desirable to have a software product that allows users to solve mathematical problems in a self-directed manner, while providing constant feedback on the user's actions, according to the fundamental rules of mathematics.

### SUMMARY OF THE INVENTION

The present invention provides a method and program for aiding students in solving mathematical problems. The invention monitors student choices as the student walks through the steps of solving a problem and provides feedback to the user indicating whether or not the user's input is correct. The invention determines if a newly entered statement correctly follows from the previous statement according to mathematical rules. The two statements are analyzed for common sub-expressions and compared against a database of mathematical rules. The database may include invalid rules corresponding to common mistakes. The invention then provides the user feedback in the form of the rule to which the user's input corresponds.

Once the software detects the rule that the user is applying, there are several options for additional feedback. For example, the software may supply a hyperlink into an online textbook where the rule is discussed. Alternatively, the software may provide a page reference to a print textbook book. The invention may also provide a link into another online help system or a link to a tutorial page which might show other ways of applying the rule. This information can also be stored in a database so that a teacher can review the concepts with which a student is struggling or excelling. If no rule is found in the database, a general error signal is provided.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a data processing system in which the present invention may be implemented;

FIG. 2 depicts a block diagram of a data processing system in which the present invention may be implemented;

FIG. 3 depicts a flowchart illustrating the process of monitoring student input and providing feedback in accordance with the present invention; and

FIG. 4 depicts a flowchart illustrating the steps of converting an input statement into an n-ary tree; FIG. 5 depicts a flowchart illustrating the process of removing extraneous sub-expressions in accordance with the present invention;

FIG. 6 depicts a flowchart illustrating the process of refactoring common sub-expressions after extraneous sub-expressions have been removed in accordance with the present invention; and

FIG. 7 depicts a flowchart illustrating the substitution checking process in accordance with the present invention.

### DETAILED DESCRIPTION OF THE INVENTION

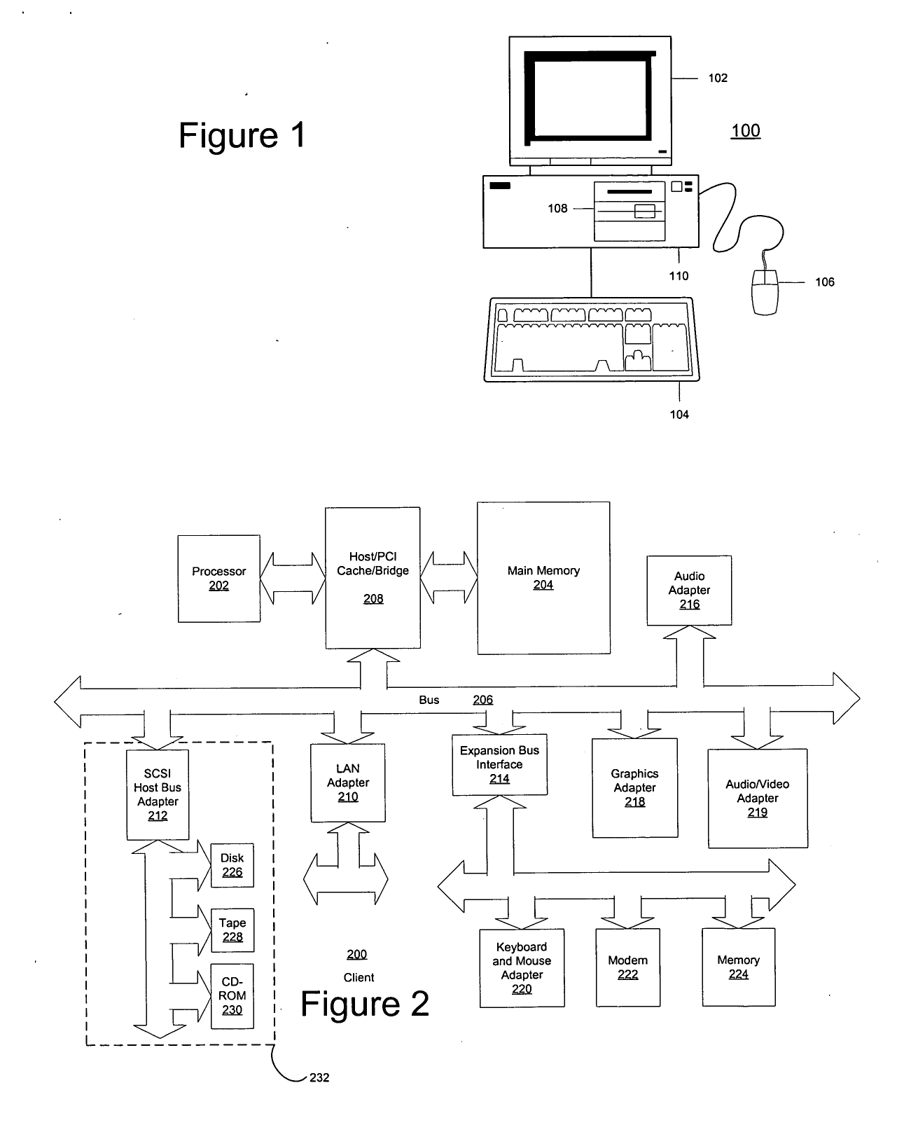

With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

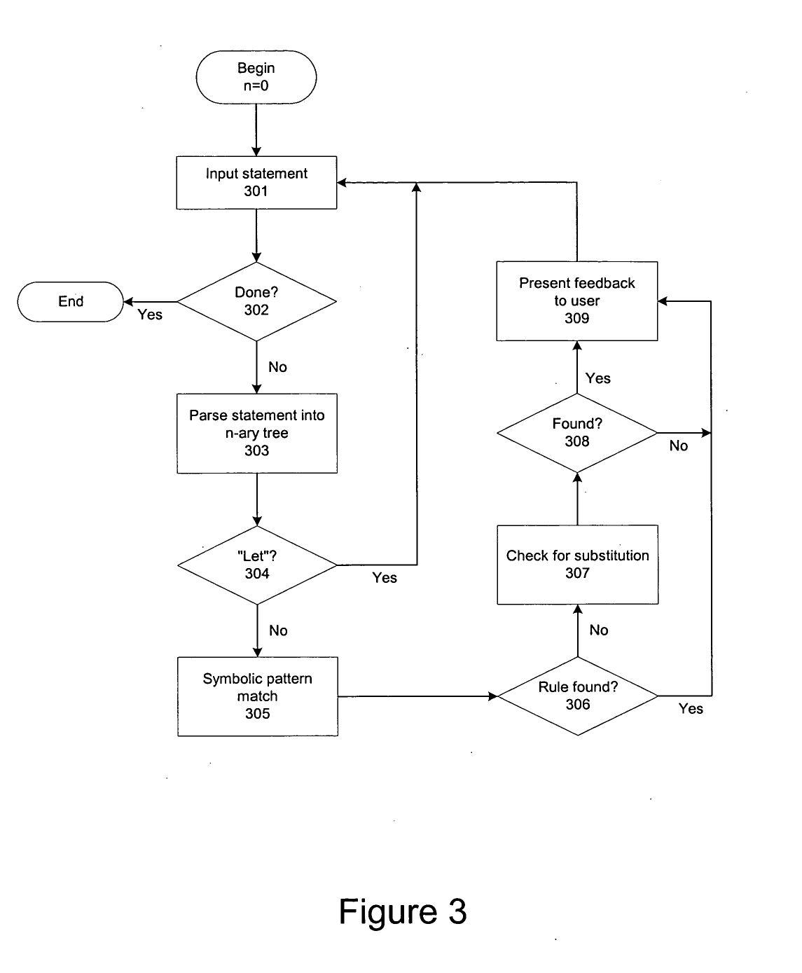

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention works on math problems. The software monitors student choices as the student works through the steps of solving a problem and notifies the student as soon as a mistake is made. When the student is notified about a mistake, the software will attempt to detect the type of error made and offer hints as to the correct operation and/or provide a link to a textbook section for review. However, the invention does not direct the student through the problem solving steps. Neither does the invention solve the problem for the student. Instead, the invention only enforces the hard and fast rules of mathematics and arithmetic as the student performed steps in solving a problem and notifies the student when those rules are violated.

The description below will use the example of solving algebra problems. However, the invention may easily be applied to any type of math problem, e.g., arithmetic, trigonometry, geometry, and calculus.

In the present example, the input to the program is a sequence of algebraic statements, i.e., s[0], . . . , s[n−1]. These statements are entered one at a time, and the program remembers all previous statements. There are three types of statements: LET, THEREFORE, and DONE. The following is an example of user input, in which the student has been asked to solve for x:
s[0]: xy=x+y
s[1]: xy+x=y
s[2]: xy−x=y
s[3]: x(y−1)=y
s[4]: x=y/(y−1)
s[5]: let y=4
s[6]: x=1⅓
s[7]: done

In the above example, n=8. The first input statement is always assumed to be a LET statement. Subsequent statements are assumed to be THEREFORE statements, unless the statement begins with the keyword LET. Note that statement s[1] is an error.

The user enters the algebraic statements one at a time and is given either positive or negative feedback after each step. The user might interact with the program via a command line interface and a graphical equation editor. However, many options exist within the art by which the user may interface with the invention. Other examples include graphical environment, calculator with embedded software, tablet computer, and PDA with pen interface.

The following is an example of a user interaction with the invention within a text environment:
s[0]: xy=x+y
s[1]: xy+x=y
   No, check your signs.
s[2]: xy−x=y
   Yes, you subtracted x from both sides.
s[3]: x(y−1)=y
   Yes, you factored out an x.
s[4]: x=y/(y−1)
   Yes, you divided both sides by y−1.
s[5]: let y=4
   Ok.
s[6]: x=1⅓
   Yes, you performed a simple arithmetic operation.
s[7]: done
   Goodbye.

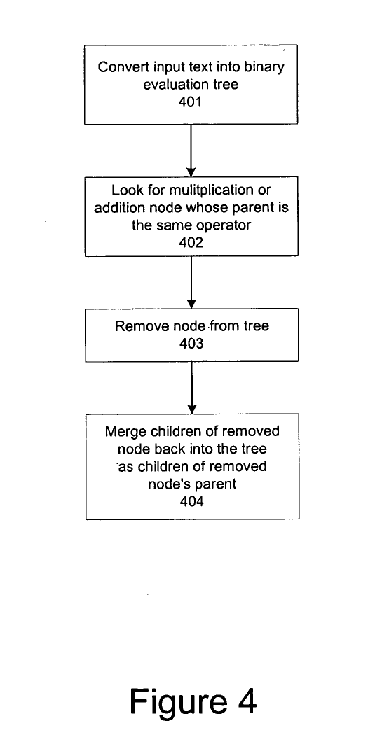

Referring now to FIG. 3, a flowchart illustrating the process of monitoring student input and providing feedback is depicted in accordance with the present invention. The process begins at n=0 with the initial LET statement; using the above example, s[0]: xy=x+y. The student then enters the next statement (step 301). The program checks to see if the statement entered by the user is a DONE statement (step 302). If the statement is DONE, the student is finished and the process terminates. If the statement s[n] entered in step 301 is not DONE, the invention parses it into an n-ary tree (step 303).

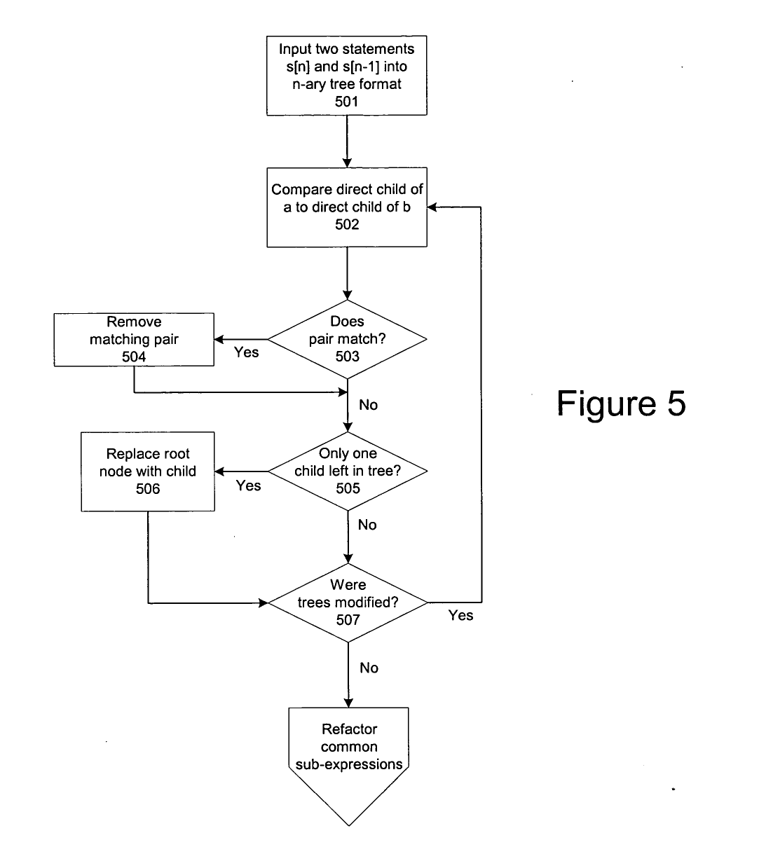

FIG. 4 is a flowchart illustrating the steps of converting the input statement into an n-ary tree. The first step in this process is to convert the input text, s[n], into a binary evaluation tree (step 401). For example, the binary evaluation tree for the statement s[n]: x=a+b+c would be:

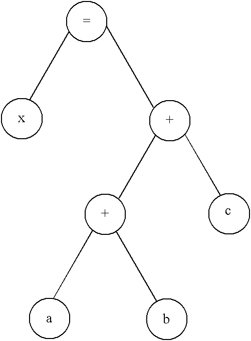

The present invention deviates from standard generation of binary evaluation trees in two ways. First, subtraction operations are converted to addition of minus values, e.g., x−5 becomes x+(−5), which simplifies later processing. Second is to support implicit multiplication. In this way, users my simply enter xyz (wherein the multiplication to these operands is assumed) rather than having to enter x*y*z. The invention takes care of this by preprocessing the input to this block. All tokens are scanned looking for operands, and if two operands are found together (without an operator between them), a multiply operator is inserted.

This feature can be turned off to support user interfaces that allow the user to use multiple character variables (e.g., “profit=revenues-expenses”). When in this mode, a space between operands is treated like the multiplication operator (e.g., Force=Mass Acceleration).

After the binary tree evaluation is built, the program searches the tree from the bottom up and left to right, looking for a multiplication or addition node whose parent is the same type of operator (step 402). If such a parent node is found, the child node is removed from the tree, since it is redundant (step 403). Finally, the children of the removed node are merged back into the tree as children of the removed node's parent (step 404). Using the example tree above, the addition node linking “a” and “b” has a parent node that is also an addition operator. Therefore, the child addition node is removed. The “a” and “b” nodes then become children of the parent addition node. The final n-ary tree would look like the following:

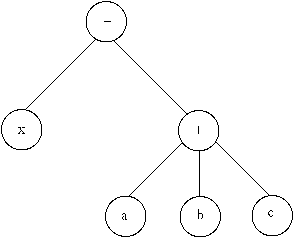

Returning to the flowchart in FIG. 3, after the n-ary tree is built, the program determines if the statement in question is a LET statement (step 304). As explained above, the beginning statement, s[0], is assumed to be a LET statement. Any subsequent LET statement must be explicitly denoted as such by the user. If the statement in question, s[n], is a LET statement, the program returns to step 301 and retrieves the next statement.

If the statement, s[n], is not a LET statement, the program performs a symbolic pattern match (step 305). Symbolic pattern matching involves comparing the statement in question, s[n], to the previous statement, s[n−1], and producing a result, r[n], indicating whether or not s[n] does indeed follow from s[n−1]. Symbolic pattern matching comprises three main sub-processes: 1) removal of extraneous sub-expressions, 2) refactoring common sub-expressions, and 3) rule comparison.

FIG. 5 is a flowchart illustrating the process of removing extraneous sub-expressions. The two statements being matched, s[n] and s[n−1], are input into n-ary tree format (step 501). For this example, the root nodes of these trees will be called “a” and “b”. The program compares all of the direct children of node “a” to the direct children of node “b” (step 502) and determines if any pair of children matches (step 503). If a pair of direct children nodes does match, they are removed (step 504).

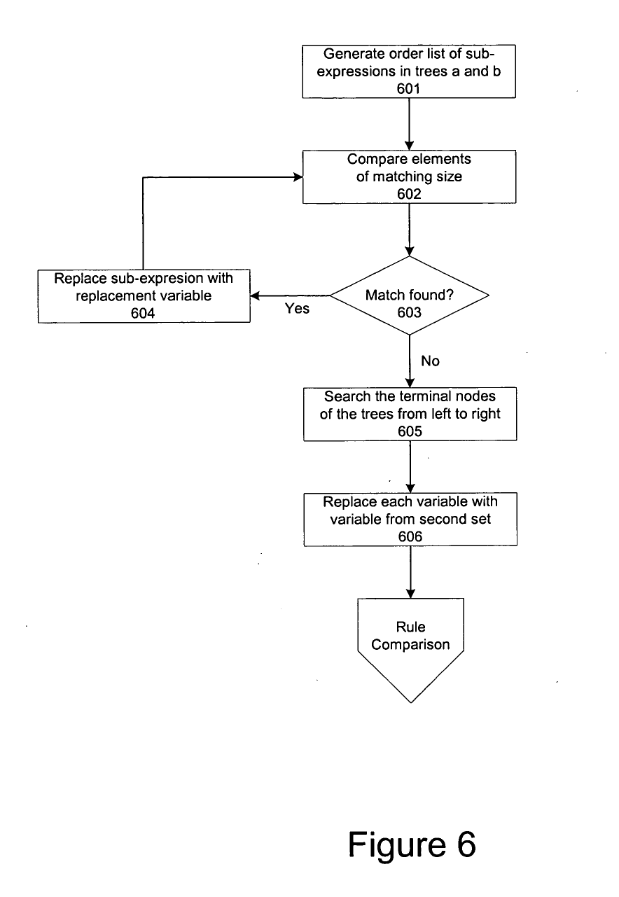

After the matching children have been removed, the invention determines if either node “a” or “b” is left with only one child (step 505). If so, that node is replaced by the child node (step 506). The invention then determines if a modification was made to the trees in the previous steps (step 507). If the trees were modified, the process returns to step 502. Otherwise, the process ends, and the program then proceeds to the process of refactoring the common sub-expressions (explained in more detail in FIG. 6 below).

The following example will help illustrate the process depicted in FIG. 5 for removing extraneous sub-expressions. The two statements being matched are:
s[n−1]: 15x+17xy+cy=17
s[n]: x(15+17y)+cy=17
   Since 17 is a common child node in the tress for both statements, it is removed. The equal sign (=) is also removed because the left hand sign + is the only child remaining. Therefore, after the first iteration, the statements are:
s[n−1]: 15x+17xy+cy
s[n]: x(15+17y)+cy
   Since “+cy” is common to both trees, it is also removed. Thus, after the second iteration, the statements are now:
s[n−1]: 15x+17xy
s[n]: x(15+17y)

FIG. 6 is a flowchart illustrating the process of refactoring common sub-expressions in the statements after the extraneous sub-expressions have been removed. This is the second main sub-process in symbolically matching the statements in step 305 of FIG. 3.

The term refactor is a concept well known in computer programming. Refactoring code involves taking a part out of the code, segregating it into its own routine, and then calling the routine from the original code. It is a standard way of simplifying computer code. The present invention applies the concept of refactoring to algebraic statements. The process starts with the two statements (i.e., s[n] and s[n−1]) in an n-ary tree format, wherein extraneous sub-expressions are already removed (as described above). Again, the root nodes of the n-ary trees can be called “a” and “b”, respectively. The invention generates an ordered list of all sub-expressions of “a” and “b” in order from largest to smallest (step 601). The program then walks through this list, comparing elements of matching size (step 602) and determines if a match exists between the sub-expressions (step 603).

If a match is found between two sub-expressions in the two trees, all occurrences of that sub-expression in both statements are replaced with a variable from a pre-defined list (e.g., A, B, C, . . . , Z) (step 604). The process then returns to step 602 and looks for more matches, ignoring any sub-expressions that contain replacement variables.

The following example will help illustrate the above steps. Using the same example statements above, the input statements to be refactored are:
s[n−1]: 15x+17xy
s[n]: x(15+17y)
   Refactoring moves from the largest opportunities to the smallest. The largest common sub-expression in both statements is 17y. This sub-expression is replaced with a new variable A. The resulting statement then read:
s[n−1]: 15x+Ax
s[n]: x(15+A)
   The next largest common sub-expression in s[n] and s[n−1] is 15, which is replaced by the variable B. The statements now read:
s[n−1]: Bx+Ax
s[n]: x(B+A)
   Finally, the smallest common sub-expression is x, which is replaced by the variable C, producing the following statements:
s[n−1]: BC+AC
s[n]: C(B+A)

Returning to FIG. 6, the steps for variable substitution begin after all of the common sub-expressions have been refactored. After all common sub-expressions are replaced with variables, the variable are reordered and substituted with new variables. This is done strictly for readability. Using the n-ary trees, the program searches the terminal nodes from left to right (step 605), and each time a variable in the original defined set (i.e., A, B, C, . . . , Z) is found, all occurrences of that variable in the trees are replaced with the next available replacement variable in a second defined set (i.e. a, b, c, . . . , z) (step 607). For example, continuing with the same example above, the first set of variables is replaced with another set of variables as follows:
B→a
C→b
A→c
   This variable substitution produces the following end product:
s[n−1]: ab+cb
s[n]: b(a+c)

After the common sub-expressions are refactored, the final main element of step 305 in FIG. 3 is to compare the resulting statements to defined mathematical rules. By this point in the process, the user's input has been converted into a general form that one might see in a textbook to describe different types of algebraic operations. For example, a textbook might describe the difference of squares formula as:
a²−b²=(a+b)(a−b)
The invention compares the statements produced at the end of step 607 to a database of known legal and illegal general forms.

Each record in the database of general forms describes a single operation, indicates whether the operation is legal or illegal, and gives a text description of the operation and an ordinal number for the operation. The following is an example record:

| Field-1 | Field-2 | Field-3 | Field-4 | Field-5 |
|---|---|---|---|---|
| (ab_ + . . . ) | 016 | Distribution | + | Yes, you distributed <a> |

Field 1 defines the algebraic rule. A tilde (˜) is used instead of an equal sign (=) to show that one form implies another. The selection of the tilde is arbitrary but different from the equal sign because the equal sign can appear on either side of the rule. In addition, ellipses are used as a generalization of the sum (Σ) and product (Π) symbols that often appear in such rules.

Field 2 is the ordinal number of the rule, which provides a unique identifier for that rule within the database.

Field 3 is a description or name of the rule.

Field 4 contains a plus or minus sign. A plus indicates that the operation is valid, while a minus sign means the operation is invalid. Invalid operations are included in the database to account for common operation errors made by students. Being able to match a student's choices (i.e. statements) with an invalid rule helps to identify specifically what the student did wrong and thus provide better feedback.

Field 5 contains a longer description of the rule. The variable from Field 1 (i.e. a) appears enclosed within the greater than and less than symbols. This field is used to provide the user specific feedback in step 309 in FIG. 3 (described below). The variables are replaced before this string is presented to the user. For example, if the user entered the following step:
s[n−1]: xy(a+b+c+d)
s[n]: axy+bxy+cxy+dxy
   The string in Field 5 would be expanded to read “Yes, you distributed xy.” This is done by means of macroprocessing, which is well known in the art.

Returning to FIG. 3, the process of symbolically pattern matching a statement to the database of operations does not necessarily mean a corresponding rule will be found. Therefore, the program must determine if a rule can be found that matches the statement input by the user (step 306). If a rule is found in the database, the rule is presented to the user (step 309).

There are three possibilities resulting in the feedback provided to the user in step 309. The invention will either find a valid rule, an invalid rule, or no rule at all. The first two cases are treated the same. Any variables in the rule that are surrounded by greater than or less than signs (see table above) are replaced with the actual values in the statement in question and presented to the user.

Once the software detects the rule that the user is applying, there are several options for additional feedback. For example, the software may supply a hyperlink into an online textbook where the rule is discussed. Alternatively, the software may provide a page reference to a print textbook book. The invention may also provide a link into another online help system or a link to a tutorial page which might show other ways of applying the rule. This information can also be stored in a database so that a teacher can review the concepts with which a student is struggling or excelling.

If no rule (either valid or invalid) can be found to match the user's input, the invention checks for a substitution (step 307). If a substitution is found, it is used to evaluate the statement input by the user. The following is an example:
s[0]: 2x−3y=4
s[1]: Let 5x+4y=7
   Ok.
s[2]: 4y=7−5x
   Yes, you added −5x to both sides.
s[3]: y=(7−5x)/4
   Yes, you divided both sides by 4.
s[4]: 2x−3[(7−5x)/4]=4
   Yes, you substituted (7−5x)/4 for y.

Every statement previously entered into the system is retained. In order to perform a substitution check, the program goes back through the list of statements (s[0] . . . s[n−2]) and looks for statements in a specific format:
A=B
   wherein A and B are arbitrary expressions. In the example above, every statement fits this criterion:
s[0]: A=2x−3y, B=4
s[1]: A=5x+4y, B=7
s[2]: A=4y, B=7-5x
s[3]: A=y, B=(7−5x)/4

The program takes these expressions (A and B) and searches for them in the current statement s[n−1]. Referring to the example above, the program would find sub-expression B from s[3] in the statement s[4] and would replace B with A, yielding the following expression:
2x−3[(7−5x)/4]=4→2x−3[y]=4
This expression is s[0], which is revealed by comparing the newly generated statement with every previously entered statement that is not already being drawn upon. For example, if s[4] is the problem, A and B from s[3] are already being used. Therefore, the new expression s[4] is compared against s[0], . . . , s[2] along the lines described above.

The following is a pseudo-code example of the substitution check procedure:

Let N = # of statements
Let I = N − 1
For each i in I

If s[i] matches the general form A = B then

If A can be found in statement s[n−1]

Create new expression X by replacing sub-expression

A with sub-expression B in s[n−1]

For each j in I

If j <> i then

Compare s[j] to X
If match then terminate with a positive result

End if

End for each j in I

End if
If B can be found in statement s[n−1]

Create a new expression Y by replacing sub-expression

B with sub-expression A in s[n−1]

For each j in I

If j <> I then

Compare s[j] to Y
If match then terminate with a positive result

End if

End if each j in I

End if

End if

End for each i in I

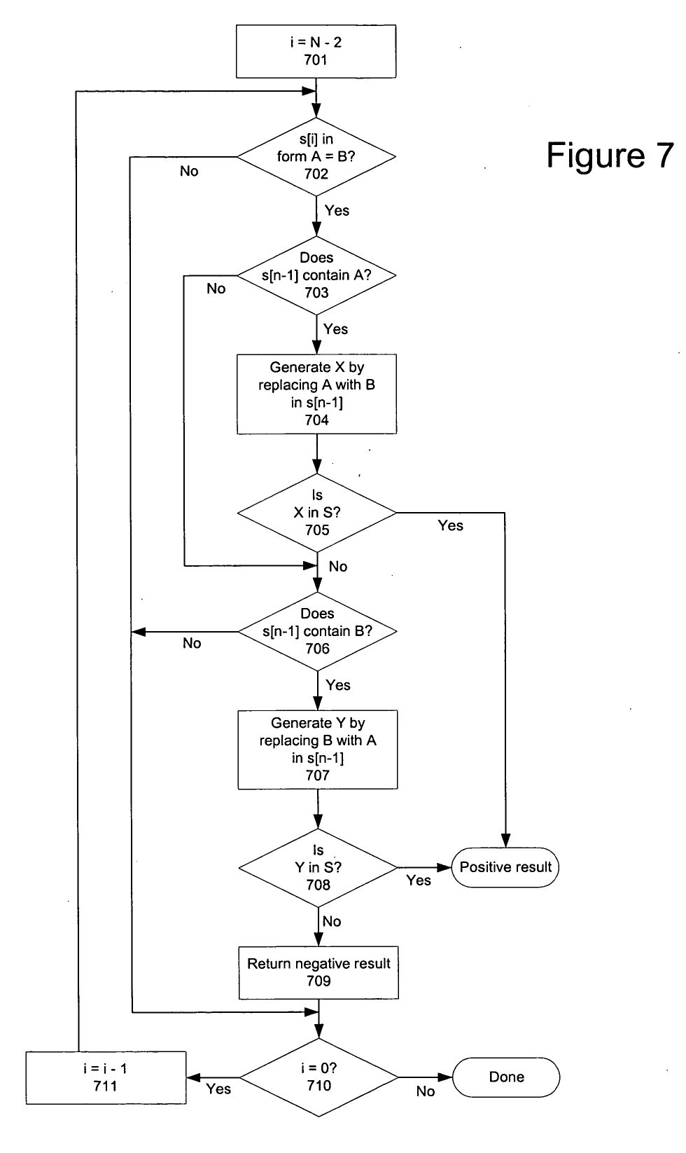

FIG. 7 depicts a flowchart illustrating the substitution checking process in accordance with the present invention. The process begins by assuming i=N−2 (step 701), and then determines if s[i] is in the form of A=B, as described above (step 702). If s[i] is not in the A=B form, the process skips it and goes to step 709.

If s[i] is in the form A=B, the program determines if the current statement s[n−1] contains A (step 703). If s[n−1] does contain A, a new expression X is generated by replacing A with B in s[n−1] (step 704). If s[n−1] does not contain A, the process skips to step 706.

The program then checks if X is in the set S (s[n−1], . . . , s[0]; all of the statements that have been entered so far) to see if a substitution has been made (step 705). If X is in one of the previously entered steps in S, the check is finished and a positive result is returned. If not, the program determines if s[n−1] contains B (step 706).

If s[n−1] does not contain B, the process moves to step 709. If s[n−1] contains B, the program generates a new expression Y by replacing B with A in s[n−1] (step 707). The program then determines if Y is in the set S (step 708). If Y is in S, the check is finished and a positive result is returned and the process ends.

If Y is not in S, the program returns a negative result (step 709). Since a substitution has not yet been found, the program continues counting down from i=N−2 to i=0. The program determines if i=0 (step 710). If so, there are no more statements in set S to evaluate, and the process is done. If i does not equal zero, then i is set to i−1 (step 711) and the process returns to step 702.

The following example will help illustrate the process depicted in FIG. 7:
s[0]: 2x−3y=4
s[1]: Let 5x+4y=7
s[2]: 4y=7−5x
s[3]: y=(7−5x)/4
s[4]: 2x−3[(7−5x)/4]=4
   In the first pass through the process flow, N=5, therefore i=3 (step 701). The answer to question 702 is yes, since s[3] is in the form of A=B:
s[3]: y=(7−5x)/4
A=y
B=(7−5x)/4
   Proceeding to question 703, the answer is no, because A=y, and s[4] does not contain y. Moving to question 706, the answer is yes, because B=(7−5x)/4, and s[4] does contain that sub-expression. Therefore, the program generates expression Y by replacing B with A in s[4]:
Y: 2x−3[y]=4
   As can be seen, expression Y is the same as s[0]. Therefore, the answer to question 708 is yes, since Y is in set S. This terminates the algorithm with a positive result, there has been a substitution.

Returning to FIG. 3, if no substitution can be found, a generic unknown error is returned to the user in step 309. This rule (ordinal 0) has the description “No”.

After the feedback is presented to the user in step 309, the process returns to step 301 and the user enters the next statement. If the user enters “done”, the process ends.

As stated above, the invention may easily be applied to any type of math problem such as arithmetic, trigonometry, geometry, and calculus. The basic principle is the same: providing real time feedback to the user as the user attempts to solve a math problem but without actually solving the problem for the user or actively guiding the user through the problem. With the present invention, the user does the work, but the invention informs the user if that work is going in the right direction with each step, rather than simply providing an all or nothing answer at the end.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for monitoring and checking the solution of mathematical problems, the method comprising the computer implemented steps of:
(a) receiving a first statement from a user, wherein the first statement represents a mathematical problem;
(b) receiving subsequent statements from the user, wherein the subsequent statements represent steps in the solution of said mathematical problem;
(c) comparing said statements against a database of mathematical rules;
(d) displaying an error signal to the user if a statement does not follow from previous statements according to said mathematical rules; and
(e) displaying a confirmation signal to the user if the statement does follow from the previous statements according to said mathematical rules.

2. The method according to claim 1, further comprising:
parsing the statements into respective data structures.

3. The method according to claim 2, further comprising removing common sub-expressions from the statements, wherein:
(1) child nodes common to the data structures are removed from the data structures; and
(2) any parent nodes with only one remaining child node after step (1) are also removed from the data structures, and replaced with that child node.

4. The method according to claim 2, further comprising:
refactoring common sub-expressions in the statements, wherein the common sub-expressions are replaced with variables.

5. The method according to claim 2, wherein the parsing supports implicit multiplication, wherein if two operands are adjacent in a statement without an operator between them, a multiply operator is inserted.

6. The method according to claim 1, wherein the database of mathematical rules contains both valid operations and invalid operations, wherein the invalid operations are included in the database to account for common mathematical errors.

7. The method according to claim 1, further comprising:
if a rule is found in the database, displaying said rule to the user.

8. The method according to claim 7, further comprising at least one of the following:
supplying a hyperlink to an online textbook:
supplying a page reference to a print textbook;
supplying a hyperlink to an online tutorial; and
storing said rule in a database that may be reviewed by a teacher.

9. The method according to claim 1, further comprising:
if a rule is not found in the database, determining if a statement contains a sub-expression substitution from a previous statement.

10. A computer program product in a computer readable medium, for monitoring and checking the solution of mathematical problems, the computer program product comprising:
(a) first instructions for receiving a first statement from a user, wherein the first statement represents a mathematical problem;
(b) second instructions for receiving subsequent statements from the user, wherein the subsequent statements represent steps in the solution of said mathematical problem;
(c) third instructions for comparing said statements against a database of mathematical rules;
(d) fourth instructions for displaying an error signal to the user if a statement does not follow from previous statements according to said mathematical rules; and
(e) fifth instructions displaying a confirmation signal to the user if the statement does follow from the previous statements according to said mathematical rules.

11. The computer program product according to claim 10, further comprising:
instructions for parsing the statements into respective data structures.

12. The computer program product according to claim 11, further comprising instructions for removing common sub-expressions from the statements, wherein:
(1) child nodes common to the data structures are removed from the data structures; and
(2) any parent nodes with only one remaining child node after step (1) are also removed from the data structures, and replaced with that child node.

13. The computer program product according to claim 11, further comprising:
instructions for refactoring common sub-expressions in the statements, wherein the common sub-expressions are replaced with variables.

14. The computer program product according to claim 11, wherein the parsing supports implicit multiplication, wherein if two operands are adjacent in a statement without an operator between them, a multiply operator is inserted.

15. The computer program product according to claim 10, wherein the database of mathematical rules contains both valid operations and invalid operations, wherein the invalid operations are included in the database to account for common operation errors.

16. The computer program product according to claim 10, further comprising:
if a rule is found in the database, instructions for displaying said rule to the user.

17. The computer program product according to claim 16, further comprising instructions for at least one of the following:
supplying a hyperlink to an online textbook:
supplying a page reference to a print textbook;
supplying a hyperlink to an online tutorial; and
storing said rule in a database that may be reviewed by a teacher.

18. The computer program product according to claim 10, further comprising:
if a rule is not found in the database, instructions for determining if a statement contains a sub-expression substitution from a previous statement.

19. A system for monitoring and checking the solution of mathematical problems, the system comprising:
(a) input means for receiving a first statement from a user, wherein the first statement represents a mathematical problem;
(b) input means for receiving subsequent statements from the user, wherein the subsequent statements represent steps in the solution of said mathematical problem;
(c) a comparator for comparing said statements against a database of mathematical rules;
(d) a display means for displaying an error signal to the user if a statement does not follow from previous statements according to said mathematical rules; and
(e) a display means for displaying a confirmation signal to the user if the statement does follow from the previous statements according to said mathematical rules.

20. The system according to claim 19, further comprising:
A parser for parsing the statements into respective data structures.

21. The system according to claim 20, further comprising means for removing common sub-expressions from the statements, wherein:
(1) child nodes common to the data structures are removed from the data structures; and
(2) any parent nodes with only one remaining child node after step (1) are also removed from the data structures, and replaced with that child node.

22. The system according to claim 20, further comprising:
means for refactoring common sub-expressions in the statements, wherein the common sub-expressions are replaced with variables.

23. The system according to claim 20, wherein the parser supports implicit multiplication, wherein if two operands are adjacent in a statement without an operator between them, a multiply operator is inserted.

24. The system according to claim 19, wherein the database of mathematical rules contains both valid operations and invalid operations, wherein the invalid operations are included in the database to account for common mathematical errors.

25. The system according to claim 19, further comprising:
if a rule is found in the database, means for displaying said rule to the user.

26. The system according to claim 25, further comprising at least one of the following:
means for supplying a hyperlink to an online textbook:
means for supplying a page reference to a print textbook;
means for supplying a hyperlink to an online tutorial; and
means for storing said rule in a database that may be reviewed by a teacher.

27. The system according to claim 19, further comprising:
if a rule is not found in the database, means for determining if a statement contains a sub-expression substitution from a previous statement.
